(19) United States
(12) Patent Application Publication
(10) Pub. No.: US 2007/0298398 A1
(43) Pub. Date: Dec. 27, 2007

(54) Sound Reproducing Device

(76) Inventors: Alexandr Vitalievitch Smirnov, Moscow (RU); Alexei Vladimirovitch Chechendaev, Vladimir (RU)

Correspondence Address: Yury Vladagin, 6038 Tyndall Avenue, Bronx, NY, 10471, US

(21) Appl. No.: 10/450,552

(22) PCT Filed: Dec. 11, 2001
(86) PCT No.: PCT/RU01/00540

§ 371 Date: May 16, 2007

(30) Foreign Application Priority Data
Dec. 15, 2000 (RU) 2000131302

(51) Int. Cl. G09B 5/06

(52) U.S. Cl. 434/309; 434/317; 462/55

(57) ABSTRACT

The sound-reproducing device according to the first embodiment of the invention comprises a front and back covers fastened together with sheets located therebetween, a sound message reproducing unit, a impact sensors unit and sheet position detecting unit the output of which is connected to an additional input of sound message reproducing unit. This provides an automatic detection of the number of the open sheet taken into account when a sound message is selected. Impact sensors unit comprises an activation point detection unit, N sensors, a commutator, and a pulse former. The activation point is determined according to capacity changes between the cirresponding sensor and the common bus. The sound-reproducing device according to the second embodiment of the invention further comprises a message number forming unit, the first and second inputs of which are connected to the outputs of sheet position detection unit and impact sensors unit, and the output is connected to the input of sound message reproducing unit. Both embodiments provide a reliable operation of the device with a big number of book sheets.

### THE FIELD OF THE INVENTION

The invention relates to radio-electronics and more particularly to devices for sound message reproduction and can be used in devices for educational, entertaining and advertising purposes, where sound messages accompany printed texts and graphic illustrations.

### BACKGROUND OF THE INVENTION

Russian Federation patent No 2141134 to McTaggart, 1993, discloses a sound-reproducing device comprising a front and back covers fastened together with sheets located between them and a audible message reproducing unit.

The above device is made in a form of a book, in which the sheets comprise sensors connected to the audible message reproducing unit. When the user touches any of the sensors, an audible message is reproduced corresponding to the text and illustration on the sheet exactly at the point of the sensor location.

The drawback of the above device is its limited functionality. The complicated design of the sheets with sensors and connecting wires does not allow to produce books comprising a big number of sheets.

The most close to the present invention device is the sound-reproducing device disclosed in EP 0686055 to Jessob, 1997. The device according to Jessob comprises a front and a back covers fastened together with sheets located between them, an audible message reproducing unit, and impact sensors unit located so that it detects the user actions, and the output of said unit is connected to the input of the audible message reproduction unit.

The above device is implemented in a form of a book with located in its covers capacity sensors that make up the impact sensors unit. The point where the user touches the book sheet is determined by the capacity change between the capacity sensor located in the cover under the point where the sheet is touched and the common bus of the device. The number of the opened sheet is determined by touching special markings on the sheet, under which there are additional capacity sensors in one of the book covers, said additional sensors being a part of the impact sensors unit. The impact sensors unit transmits data about the user actions to the sound-reproducing unit. The message for the reproduction is determined by the number of the open sheet and the point where the user touches this sheet.

The drawback of the above device is its limited functionality, because the sheet number cannot be determined automatically. If the user turning over a new sheet forgets to touch the marking or fulfills this operation incorrectly, the wrong sound message will be reproduced. This drawback makes it difficult to produce sound-reproducing books with a big number of sheets. As the number of sheets increases, the number of markings increases accordingly and the input of the sheets number becomes complicated and time-taking.

The other limitation of the device according to Jessob is its comparative operation unreliability. The capacity between the capacity sensor in the cover and the common bus of the device depends on the number of sheets located above this cover. The change of said capacity taking place when many sheets are turned over, is comparable to the change of said capacity upon the user touch of the sheet that can result in mistakes in touch detection.

### OBJECTS AND SUMMARY OF THE INVENTION

It is an object of the present invention to provide a sound-reproducing device simple in use due to automatic means and reliable having a big number of sheets.

A sound-reproducing device according to the first embodiment of the invention comprises a front and back covers fastened together with sheets located therebetween, a sound message reproducing unit, an impact sensors unit, the output of which is connected to the input of the sound message reproducing unit, sheet position detection unit, the output of which is connected to an additional input of said sound message reproducing unit, wherein said impact sensors unit is located so that to be capable of detecting user actions, said sheet position detection unit is located so that to be capable of determining sheets positions, and said sound message reproducing unit is operative to reproduce sound messages depending on code numbers on its inputs.

Further, the sound message reproducing unit is located in the space limited by surfaces of at least one of the front cover and back cover.

Further, the impact sensors unit comprises an activation point detection unit, N sensors, a commutator, and a pulse former, each of the sensors being located in the front or back cover or on the surface of one of the covers and being connected to the corresponding input of the commutator, the output of which via the pulse former is connected to the input of the activation point detection unit, the first output of which is the output of the impact sensors unit and the second output is connected to the control input of the commutator.

Further, the activation point detection unit, commutator and pulse former are located in the space limited by surfaces of at least one of the front cover and the back cover.

Further, at least one of said sensors is a capacity sensor.

Further, at least one sensor comprises a fragment of a metallized coating of the circuit board.

Further, at least one sensor comprises a fragment of a conducting coating on an insulating film.

Further, the activation point detection unit is operative to form on its second output cyclically repeating codes of numbers from 1 to N; to measure N pulse periods on its input corresponding to numbers from 1 to N; to store N pulse periods corresponding to numbers from 1 to N; and to form on its first output a code of number K so that the difference between the K-th measured period and the K-th earlier stored period is maximal for all measured periods from the first till the N-th and exceeds a preset threshold.

Further, the pulse former comprises a threshold element, the input of which is the input of the pulse former and via a resistor is connected to a common bus, the output of the threshold element is the output of the pulse former, and wherein the commutator comprises an additional input connected to the output of the pulse former, a demultiplexer and a multiplexer, control inputs of which are connected to the input of the commutator, the output of which is connected to the output of the multiplexer, and an additional input is connected to the input of the demultiplexer, each out of at least part of outputs of which is connected to each out of at least part of inputs of the multiplexer via a consecutively connected resistor and diode, the united outputs of which are connected to a corresponding output of the commutator.

Further, the sheet position detection unit comprises a sheets position sensor and an interrogation unit, the input of which is connected to the output of the sheets position sensor and the output being the output of the sheet position detection unit.

Further, the interrogation unit is operative to cyclically form codes of numbers from 1 to L on its additional output connected to the input of the sheets position sensor, and wherein the sheets position sensor comprises L electrodes, an alternating voltage generator, a demultiplexer, a multiplexer, and a comparator, the output of which is the output of the sheets position sensor, and the input is connected to the output of the multiplexer, the control input of which is connected to the input of the sheet position sensor and is connected to the control input of the demultiplexer, the input of which is connected to the output of the alternating voltage generator, the electrodes being displaced on at least part of the sheets so that capacity connection appears between the electrodes on adjoining sheets, when the sheets adjoin each other, and each of the electrodes being connected at least to the corresponding output of the demultiplexer and to the corresponding input of the multiplexer.

Further, the sheets position sensor comprises at least one of an additional electrode displaced on the inner side of the front cover and an additional electrode displaced on the inner side of the back cover, and wherein each of the additional electrodes is connected at least to the corresponding output of the demultiplexer and to the corresponding input of the multiplexer.

The sound-reproducing device according to the second embodiment comprises a front and back covers bound together with sheets displaced therebetween, a sound message reproducing unit, an impact sensors unit displaced so that to detect the user activation, a sheet position detection unit, and a message number forming unit, the first and second inputs of which are connected to the outputs of the sheet position detection unit and the impact sensors unit accordingly, and the output is connected to the input of the sound message reproducing unit, which is operative to reproduce sound messages depending on a number code on its input.

Further, the message reproducing unit in the device according to the second embodiment of the invention can be displaced in the space limited by the surfaces of at least the front cover and the back cover.

Further, the sound message reproducing unit can be displaced outside of the space limited by the surfaces of the front and back covers.

Further, the connection between the output of the message number forming unit and the input of the sound message reproducing unit is an optical connection.

Further, the connection between the output of the message number forming unit and the input of the sound message reproducing unit is a radio connection.

In the devices according to both embodiments of the invention, the introduction of the sheet position detection unit and the peculiarities of the sound message reproducing unit provide automatic determining of an open sheet number and taking it in the account, when a message for the reproduction is selected.

Besides, the peculiarities of impact sensors unit provide automatic tracing of changes in the capacity between each capacity sensor and the common bus of the device, when the sheets are turned over. This ensures a reliable detection of the user touch when a big number of sheets are placed above capacity sensors.

### BRIEF DESCRIPTION OF THE DRAWINGS

Further the invention will be illustrated by the accompanying drawings.

FIG. 1 shows the construction of the device according to the first embodiment of the invention;

FIG. 2 shows a structural scheme of the sound-reproducing device according to the first embodiment of the invention;

FIG. 3 shows a structural scheme of the sound-reproducing device according to the second embodiment of the present invention;

FIG. 4 shows the construction of the sound-reproducing device according to the second embodiment of the present invention;

FIG. 5 shows a structural scheme of an pulse former and a commutator for the both embodiments of the present invention;

FIG. 6 shows a structural scheme of a sheet position sensor and an interrogation unit for both embodiments of the present invention;

FIG. 7 shows sheet position sensors electrodes for the both embodiments of the present invention in enlarged scale;

FIG. 8 shows a structural scheme of implementing the sound reproduction unit, interrogation unit, and the activation point detection unit in the device according to the first embodiment of the present invention;

FIG. 9 shows a structural scheme for the sound reproduction unit, interrogation unit, the activation point detection unit, and the message number forming unit in the device according to the second embodiment of the present invention;

FIG. 10 shows a flow-chart for the program run in the device according to the first embodiment of the invention;

FIG. 11 shows a flow-chart for the program run in the device according to the second embodiment of the invention;

FIG. 12 shows a flow-chart for the subroutine of determining the point of activation for the both embodiments of the invention;

FIG. 13 shows a flow-chart for the subroutine of determining the open sheet number for the both embodiments of the present invention.

### THE PREFERRED EMBODIMENT OF THE INVENTION

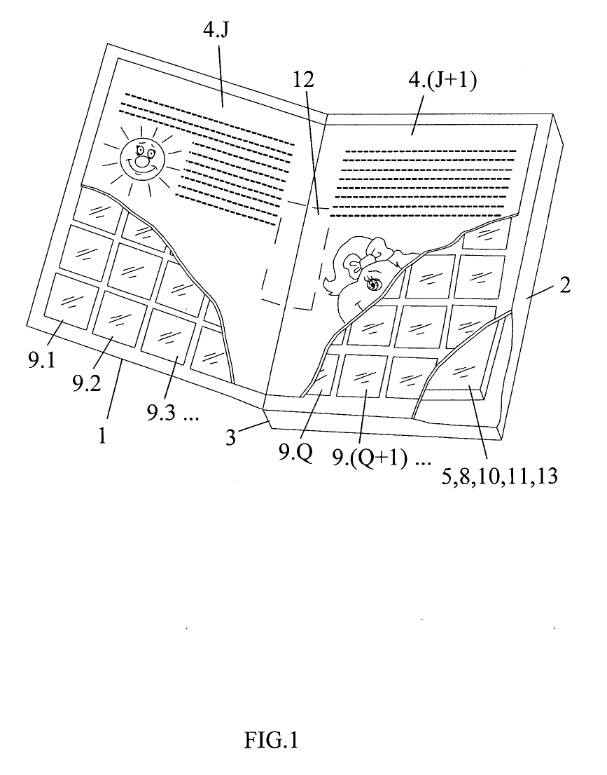

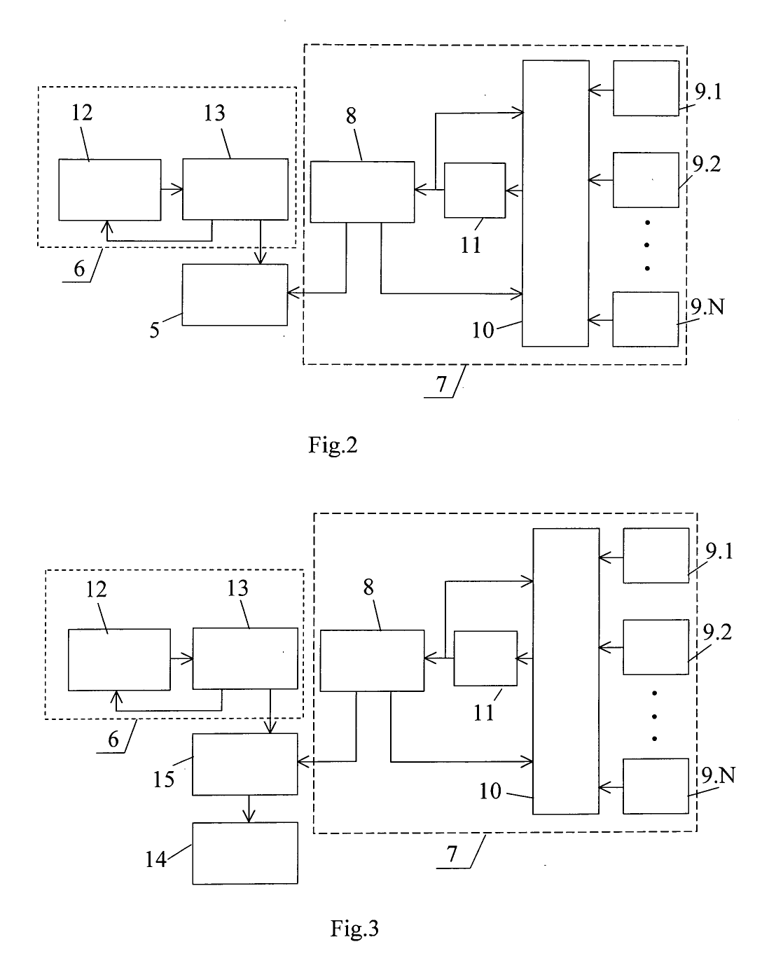

The sound-reproducing device according to the first embodiment of the present invention (FIG. 1 and FIG. 2) comprises front cover 1 and back cover 2 fastened by bounding 3 with sheets 4.1 . . . 4.M located between them, sound message reproducing unit 5, sheet position detection unit 6, impact sensors unit 7.

The outputs of impact sensors unit 7 and of sheet position detection unit 6 are accordingly connected to the input and the additional input of sound message reproducing unit 5 operative to reproduce sound messages depending on number codes on said inputs.

The device according to the first embodiment of the present invention is implemented in a form of a book shown open so that the sheets from 4.1 to 4.J are turned over, and the sheets from 4.(J+1) to 4.M are not turned over. On at least some of the sheets 4.1 . . . 4.M on one or both sides there are texts and/or illustrations made in some known way. Sound message reproducing unit 5 can be located in the space limited by the surfaces of first cover 1 (that is inside the cover that has to have sufficient thickness) and/or in the space limited by the surfaces of back cover 2, as in FIG. 1, where it is shown relatively. Sheet position detection unit 6 as a whole and impact sensors unit 7 as a whole are not shown in FIG. 1, as parts of these unit can be located in different parts of the device as it will be described further.

The device can be implemented in a form of a magazine, album, booklet, etc.

Besides, the device comprises a power supply, for example several batteries, the buses of which are connected to the supply outputs of device units (not shown in FIG. 1 and FIG. 2).The power can be switched on and off with the help of a regular switch located in an appropriate place of back cover 2. It is also possible that the power is switched on when the book is opened, and switched off when the book is closed with the use of a corresponding key-button.

Impact sensors unit 7 may comprise activation point detection unit 8, sensors 9.1 . . . 9.N, commutator 10, and pulse former 11. Each of sensors 9.1 . . . 9.N may be located in front cover 1, or in back cover 2, or on the surface of one of them, each sensor being connected to the corresponding input of commutator 10, the output of which via pulse former 11 is connected to the input of activation point detection unit 8, the first output of which is the output of impact sensors unit 7, and the second output is connected to the control input of commutator 10.

In the example of the device structure shown in FIG. 1 sensors 9.1 . . . 9.(Q−1) are located in front cover 1, sensors 9.Q . . . 9.N—in back cover 2. Activation point detection unit 8, commutator 10, and pulse former 11 may be located in the space limited by the surfaces of back cover 2 (In FIG. 2 shown relatively). They may also be located inside front cover 1 or inside both said covers, or in other places of the device.

Sensors 9.1 . . . 9.N can be capacity sensors. Each of them can comprise for example a fragment of a metallized coating of the circuit board forming the first plate of the capacitor. The second plate of the capacitor is made up by the common bus of the device (“the ground”), that can be one of power supply buses. Each of these sensors is separated from the others by strips with a remote metallized coating. The capacity between sensor 9.n (n=1 . . . N) and the common bus of the device changes, when the user touches the book sheets above said sensors or his/her hand just approaches this point.

Besides, each of sensors 9.1 . . . 9.N can comprise a strip of conducting coating on the insulating film that forms the first plate of the capacitor, the second plate of which is formed by the common bus of the device. In this case, sensors 9.1 . . . 9.N can be produced according to the same technology as membrane keyboards.

Sensors 9.1 . . . 9.N may be implemented not only as capacity sensors but as for example inductive sensors. In this case, the user has to touch the device not with his/her finger but with a special pointer comprising for example a piece of ferromagnetic material.

Activation point detection unit 8 can be operative to form on its second output cyclically repeating codes of numbers from 1 to N, to measure N values of pulse periods on its input corresponding to numbers from 1 to N, to store the values of pulse periods corresponding to numbers from 1 to N, and to form on its first output the code of number K out of the range from 1 to N, so that the difference between the K-th measured period value and the K-th earlier remembered period value is the highest among all period values from first to N-th and does not exceed the set threshold.

Impact sensors unit 7 can be based on other principles. For example, it is possible to use the measurement of spreading times of an ultrasonic signal from the transmitter built into the pointer and activated upon pressing the button in the pointer to the receivers located in the corners of the covers. Pointer coordinates can be calculates by the measured times.

Sheet position detection unit 6 can comprise sheets position sensor 12 and interrogation unit 13, the input of which is connected to the output of sheets position sensor 12, and the output is the output of sheet position detection unit 6.

Sheets position sensor 12 in FIG. 1 is shown relatively and its implementation will be considered further. Interrogation unit 13 can be located in back cover 2.

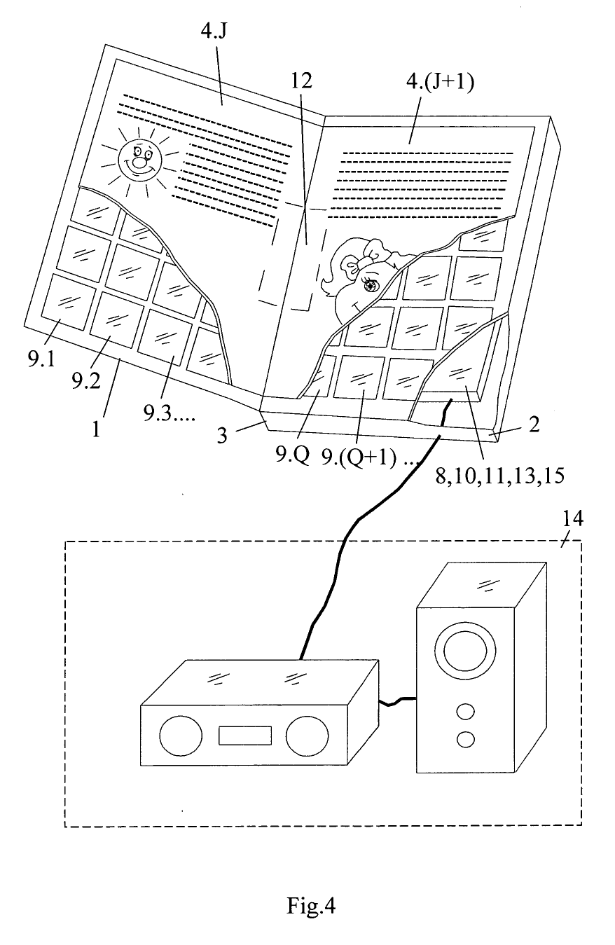

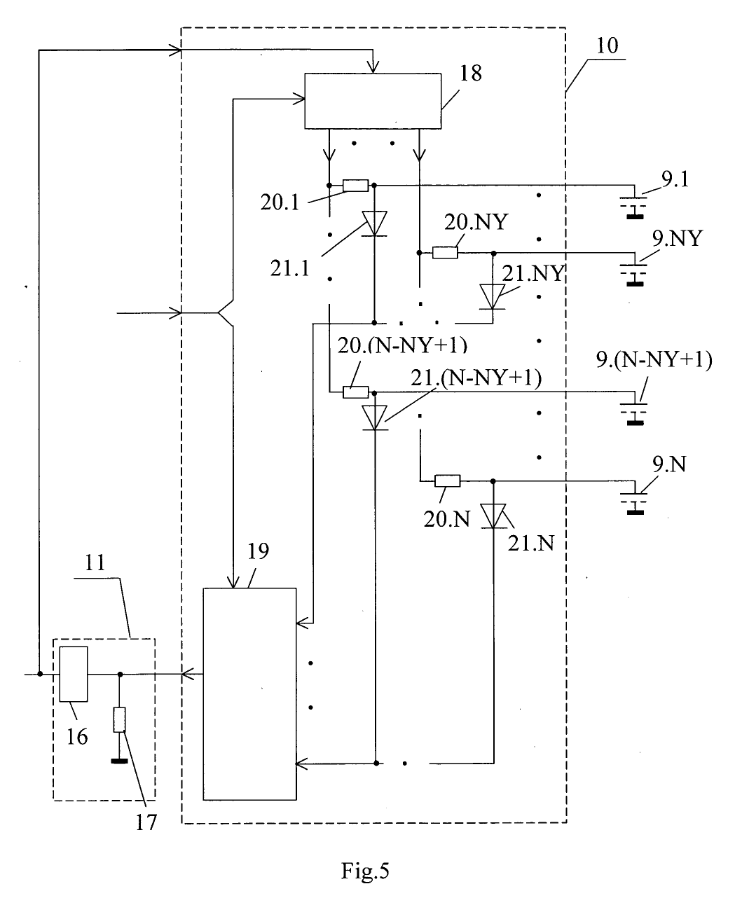

The sound-reproducing device according to the second embodiment of the present invention (FIG. 3 and FIG. 4) comprises front cover 1 and back cover 2 fastened by binding 3 with 4.1 . . . 4.M sheets located between them, sound message reproducing unit 14, sheet position detection unit 6, impact sensors unit 7, and message number forming unit 15.

The output of sheet position detection unit 6 and the output of impact sensors unit 7 are connected accordingly to the first and second inputs of message number forming unit 15, the output of which is connected to the input of sound message reproducing unit 14 operative to reproduce sound messages depending on the number code on its input.

The device according to the second embodiment of the present invention as well as the device according to the first embodiment can be implemented in a form of a book shown open so that the sheets from 4.1 to 4.J are turned over and the sheets from 4.(J+1) to 4.M are not turned over.

Sound message reproducing unit 14 can be located in the space limited by surfaces of front cover 1 and/or in the space limited by the surfaces of back cover 2, or as shown in FIG. 4 outside covers 1 and 2 in a form of a constructively separate unit. The output of message number forming unit 15 can be connected to the inputs of sound message reproducing unit 14 by wires or a radio-channel, or by for example infra-red radiation, or by other means known in the art.

Sheet position detection unit 6 and impact sensors unit 7 in the device according to the second embodiment of the present invention comprise the same units with the same specificities of construction and implementation as in the device according to the first embodiment of the invention. Message number forming unit 15 can be located inside back cover 2 (in FIG. 4 shown relatively).

Besides, the device according to the second embodiment of the invention can comprise a power supply, for example several batteries the buses of which are connected to the supply inputs of the device units (not shown in FIG. 3 and FIG. 4 ). If sound message reproducing unit 14 is made as a separate unit, it can have a separate power supply, for example of AC power. In this case, it is possible that other device units located in the book receive power supply in sound message reproducing unit 14 via corresponding wires.

In devices according to the both embodiments of the invention, pulse former 11 comprises (FIG. 5) threshold element 16, the input of which is the input of pulse former 11 and via resistor 17 connected to the common bus, and the output is the output of pulse former 11. Commutator 10 is equipped with an additional input connected to the output of pulse former 11 (also shown in FIG. 2 and FIG. 3) and comprises demultiplexer 18, multiplexer 19, resistors 20.1 . . . 20.N and diodes 21.1 . . . 21.N. The control inputs of demultiplexer 18 and multiplexer 19 are connected to the input of commutator 10, the additional input of which is the input of demultiplexer 18 and the output is the output of multiplexer 19. Demultiplexer 18 has NY outputs, and multiplexer 19 has NX inputs. In the construction being described, NX×NY=N, but this condition generally speaking is not compulsory. The K-th output of demultiplexer 18 (K=1 . . . NY) is connected to the S-th input of multiplexer 19 (S=1 . . . NX) via consecutively connected resistor 20 ((S−1)×NY+K) and diode 21.((S−1)×NY+K), the united outputs of which are connected to the ((S−1)×NY+K)-th output of commutator 10.

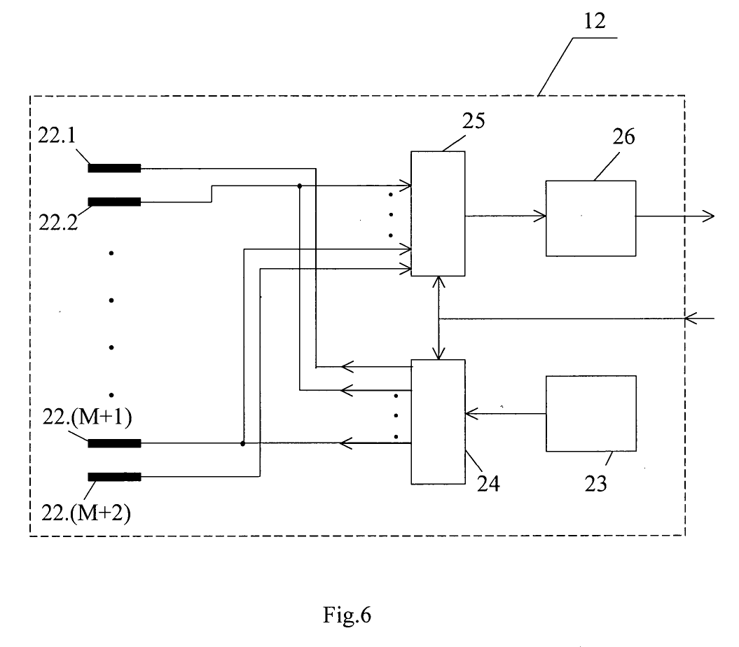

In the devices according to both embodiments of the present invention, sheets position sensor 12 may comprise (FIG. 6) electrodes 22.1 . . . 22.(M+2), AC voltage generator 23, demultiplexer 24, multiplexer 25, and comparator 26, the output of which is the output of sheets position sensor 12, and the input is connected to the output of multiplexer 25, the control input of which is connected to the input of sheets position sensor 12 and connected to control input of demultiplexer 24, the input of which is connected to the output of AC voltage generator 23. The outputs of demultiplexer 24 from the first to the (M+1)-th are connected to electrodes 22.1 . . . 22.(M+1), respectively. The inputs of multiplexer 25 from the first to the (M+1)-th are connected to electrodes 22.2 . . . 22.(M+2). The input of sheets position sensor 12 is connected to the additional output of interrogation unit 13 (also shown in FIG. 2 and FIG. 3), which can be made operative to cyclically form on its additional output codes of numbers from 1 to (M+1). The sheets position sensor 12 can be also made without an input and the corresponding connection to the output of interrogation unit 13 (not shown in the drawings). In this case, sheets position sensor 12 can comprise a clock generator connected to a pulse counter, the output of which is connected to control inputs of multiplexer 25 and demultiplexer 24 and to the output of sheets position sensor 12.

AC voltage generator 23, demultiplexer 24, multiplexer 25, and comparator 26 can be located in front cover 1 and/or in back cover 2 (not shown in FIG. 2 and FIG. 3). Upon supplying the code of number n to the control input of demultiplexer 24, the signal from its input goes to the (n+1)-th output and other outputs remain in the locked (high-Ohmed) position.

It is also possible that demultiplexers 18 and 24 are implemented as one demultiplexer integrated circuit (IC) and their functions are fulfilled by different groups of outputs of this integrated circuit. Similarly, multiplexers 19 and 25 can be implemented as one multiplexer integrated circuit. In this case, former 11 and AC voltage generator 23 are one generator.

Electrode 22.1 is located on the inner side of front cover 1 near binding 3. Electrodes 22.2 . . . 22.(M+1) are located on sheets 4.1 . . . 4.M accordingly near binding 3. Electrode 22.(M+2) is located on the inner side of back cover 2 near binding 3. In other embodiments of the device, electrodes can be placed not on every sheet and/or can be absent from the covers. In this case, the range of variation of the number formed at the additional output of interrogation unit decreases.

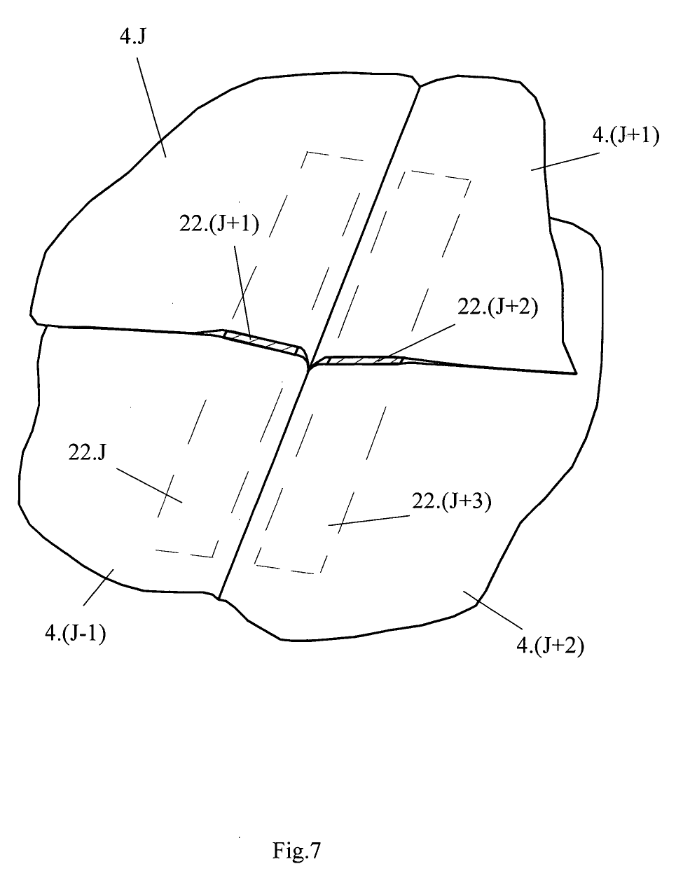

Each of electrodes 22.1 . . . 22.(M+2) can be implemented in a form of a foil plate fastened to one of the sides of the sheet (or a cover) and covered by some insulating material. Sheets 4.1 . . . 4.M can be implemented as double sheets (FIG. 7) by gluing together of two sheets of paper. In this case, electrodes 22.2 . . . 22.(M+1) can be inserted between the sheets and the insulating material is not required.

FIG. 7 shows the location of electrodes on sheets 4.(J−1) . . . 4.(J+2) shown partially and in enlarged scale. The last turned over sheet 4.J and the preceding list 4.(J−1) touch each other. In the results there is a capacity connection between electrodes 22.(J+1) and 22.J located on these sheets. Similarly, there is capacity connection between electrode 22.(J+2) on sheet 4.(J+1) and electrode 22.(J+3) on sheet 4.(J+2). At the same time, between electrode 22.(J+1) on sheet 4.J and electrode 22.(J+2) on sheet 4.(J+1) there is almost no capacity connection, because the first of said sheets is turned over and the second is not.

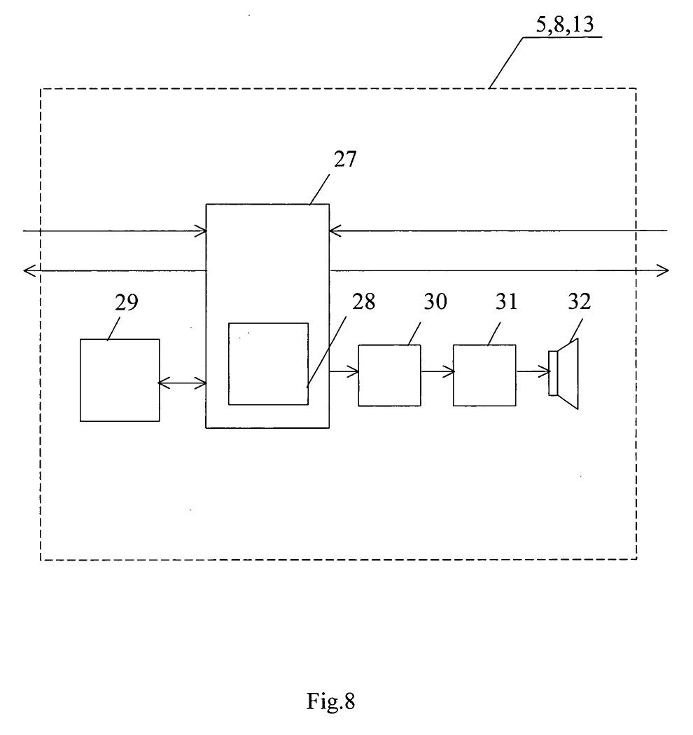

The structural scheme of implementing sound message reproducing unit 5, interrogation unit 13 and activation point detection unit 8 in the device according to the first embodiment of the present invention (FIG. 8) shows controller 27 comprising memory 28 and connected to it message memory 29, and consecutively connected to digital-to-analog converter (DAC) 30, amplifier 31, and loudspeaker 32.

Controller 27 can be implemented on for example microprocessor Atmel Inc., with memory 28 comprising non-volatile memory of 8 Kbyte for storing programs run by microprocessor, and operating memory of 256 byte for storing variables during the fulfilling of programs.

The functions of the input and the second output of activation point detection unit 8, input and additional output of interrogation unit 13 are fulfilled by designated for this purposes bits of input/output ports of microcontroller 27. The connections of the output of interrogation unit 13 and the first output of activation point detection unit 8 with the first and second inputs of sound message reproducing unit 5 accordingly are done by program means.

Message memory 29 can be based on an integrated circuit of non-volatile electric erasable memory, for example AT45D161 by Atmel Inc., USA. The number of memory ICs used depends on information volume in recorded messages. Message memory 29 can also be based on a miniature laser disc reproducing device or a miniature storage device on a hard disc, that allows to significantly increase the volume of sound information in the devices according to the present invention.

Sound messages are recorded during the manufacturing of the device into message memory 29 in a form of sequences of sound signals and can comprise speech messages, music fragments, various sound effects, etc. Each sound message is designated by number NM. The formula for calculating this number will be considered further.

Message memory 29 comprises address table, in which for each of numbers NM value the initial address of the message with this number and the number of bites with information in this message are recorded. If no message is designated for some of number NM, the number of bites with information equal to zero is recorded. To increase the volume of sound information recorded into message memory 29 any known method of sound compression can be used. Other not considered herein variants for the device are possible, in which messages can be recorded by the user into message memory 29.

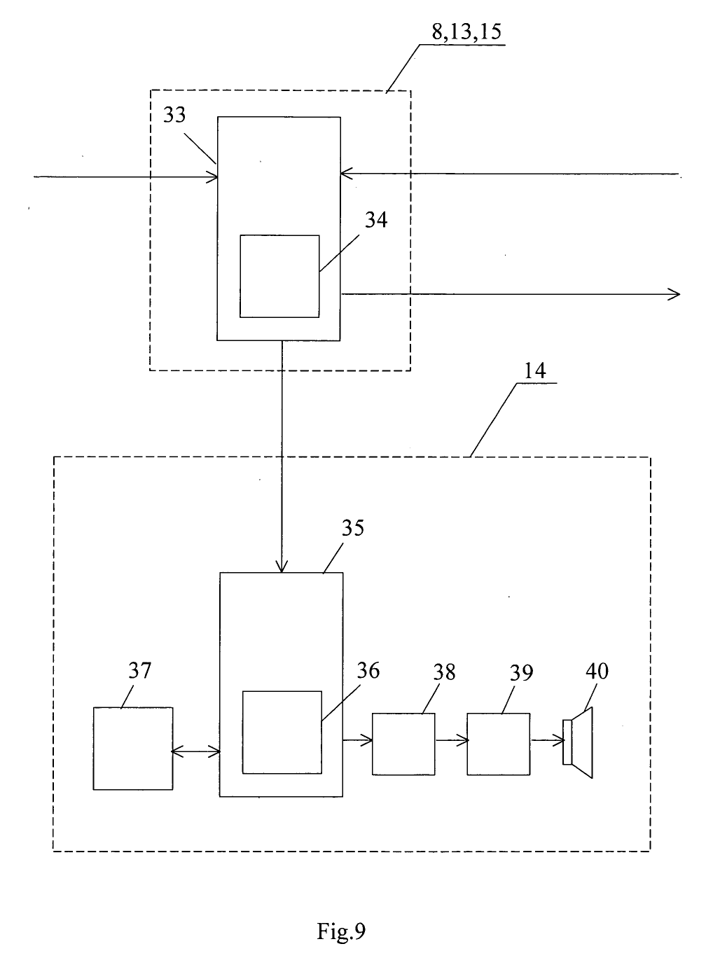

The structural scheme of sound message reproducing unit 14, interrogation unit 13, activation point detection unit 8, and message number forming unit 15 in the device according to the second embodiment (FIG. 9) shows controller 33 fulfilling the functions of interrogation unit 13, activation point detection unit 8, and message number forming unit 15, and comprising memory 34, controller 35 used in sound message reproducing unit 14 and comprising memory 36, connected to it message memory 37 and consecutively connected DAC 38, amplifier 39, and loudspeaker 40.

Controllers 33 and 35 can be implemented similarly to controller 27, and message memory 37—similarly to message memory 29 in the device according to the first embodiment of the invention.

The functions of the input and the second output of activation point detection unit 8, the input and additional output of interrogation unit 13, and the output of message number forming unit 15 is fulfilled by the designated for this purpose bits of input/output ports of microcontroller 33. The connections of the output of interrogation unit 13 and the first output of activation point detection unit 8 with the first and second inputs of message number forming unit 15 accordingly are made by program means.

If sound message reproducing unit 14 is implemented as a separate unit, it can have different constructions, for example in a form of a talking toy. The connection of the output of message number forming unit 15 and the input of sound message reproducing unit 14 in this case can be established with wires, radio-waves, infra-red rays, etc. Sound message reproducing unit 14 can be also made on the basis of a separate PC, the storage device on its hard disc serving as message memory 37, and sound card as DAC 38 and amplifier 39. The output of message number forming unit 15 and the input of sound message reproducing unit 14 in this case are connected with the use of some standard interface, for example RS-232.

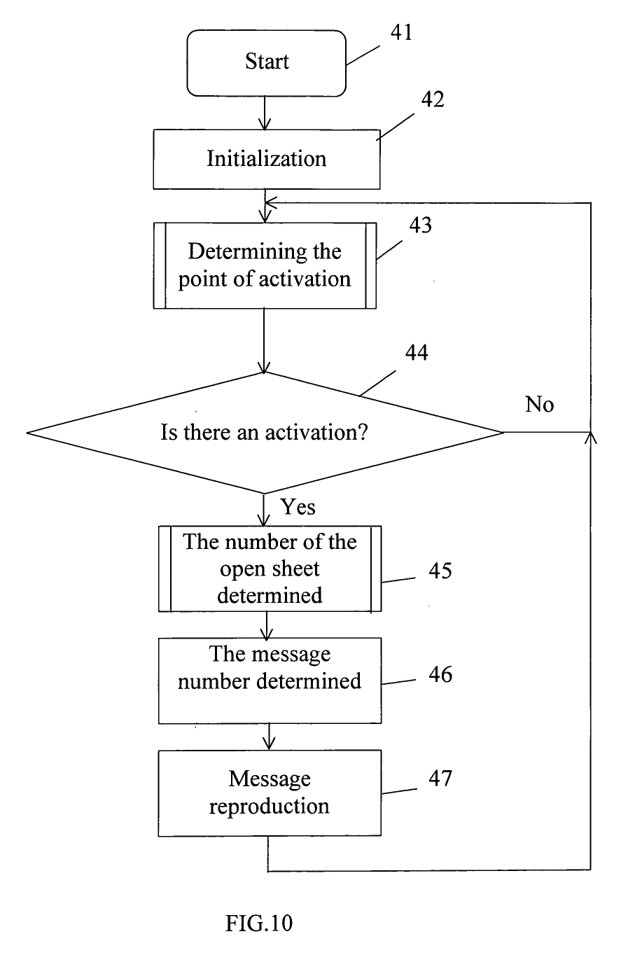

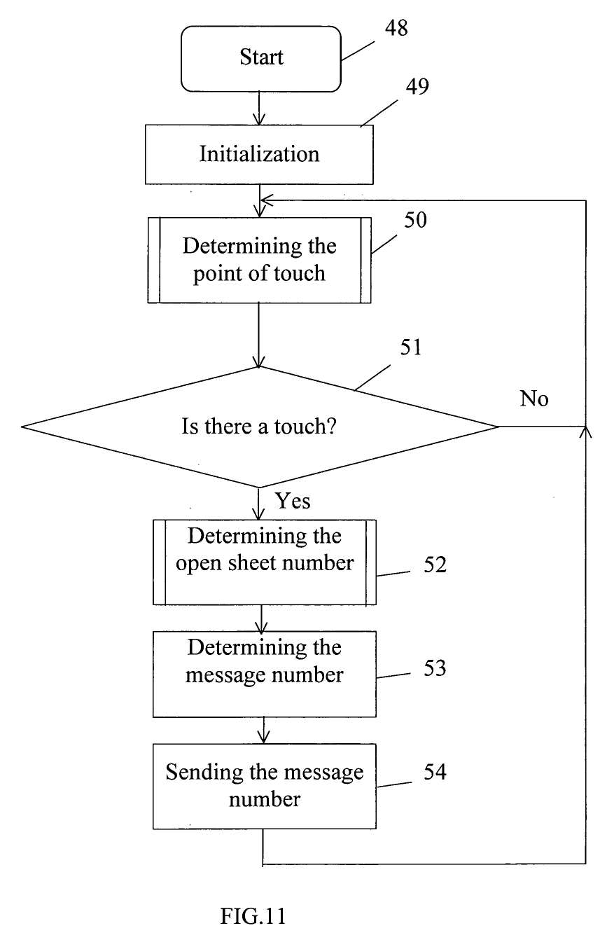

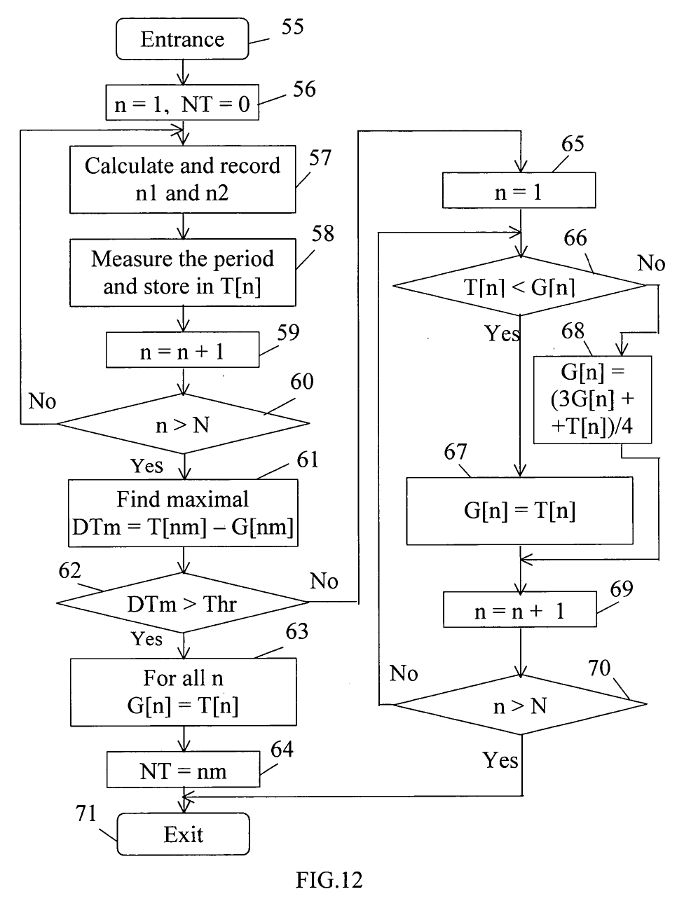

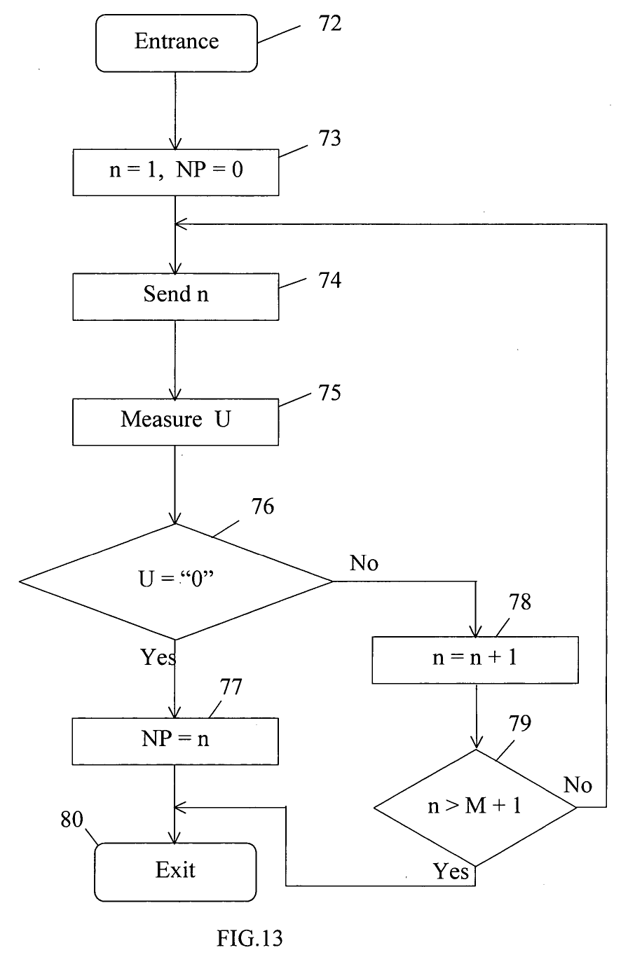

The flow-chart of the program run in the device according to the first embodiment of the present invention (FIG. 10) comprises program blocks 41 and 42, subroutine 43, program block 44, subroutines 45, program blocks 46 and 47. The flow-chart of the program run in the device according to the second embodiment of the present invention (FIG. 11) comprises program blocks 48 and 49, subroutine 50, program block 51, subroutine 52, program blocks 53 and 54. The flow-chart of the subroutine for determining the point of activation (FIG. 12) comprises program blocks 55 . . . 71. The flow-chart of subroutine for determining the number of the open sheet (FIG. 13) comprises program blocks 72 . . . 80.

### Operation of the Device

The operation of the sound-reproducing device according to both embodiments of the present invention is based on detecting the user touch of one of the open book pages with the help of impact sensors unit 7, determining the number of the open sheet with the help of sheet position detection unit 6 and reproducing a sound message corresponding to the point of touch and the number of the open sheet.

The user opens the book so that some of sheets (from 4.1 to 4.J in FIG. 7) are turned over together with front cover 1, and the rest of the sheets (from 4.(J+1) to 4.M) are not turned over together with back cover 2. The capacity connection between electrode 22.(J+1) on sheet 4.J and electrode 22.(J+2) on sheet 4.(J+1) is unlocked.

Interrogation unit 13, the functions of which in the considered embodiments are fulfilled by controller 27 (FIG. 8) and controller 33 (FIG. 9), in turn records into demultiplexer 24 and multiplexer 25 (FIG. 6) codes of numbers from 1 to M+1. When a code of some number n is being recorded, the output of AC voltage generator 23 gets connected via demultiplexer 24 to electrode 22.n, and the input of comparator 26 via multiplexer 25 gets connected via multiplexer 25 to electrode 22 (n+1). The interrogation of sheets position sensor is repeated periodically.

If electrodes 22.n and 22.(n+1) adjoin each other, then there is a capacity connection between them. AC voltage goes to the input of comparator 26, on the output of which the level of the voltage is equal to 1. If there is a sufficient distance between electrodes 22.n and 22.(n+1) corresponding to n=(J+1) (FIG. 7), the capacity connection between them is unlocked, AC voltage is not applied to the input of comparator 26, on the output of which the level of voltage is equal to 0.

In interrogation unit 13 the value of n=NP is determined, when at the output of sheets position sensor 12 the value of 0 appears. The program fulfilling this function will be described further. In the described embodiment of the invention, the number of the last turned over sheet is equal to NP−1, and the number of the first not turned over sheet is equal to NP. If only front cover 1 is turned over, then NP=1. If all the sheets are turned over and back cover 2 is not, then NP=M+1.

Determining of the point of touch is based on detecting the capacity increase between the common bus of the device and sensor 9.n (where n=1 . . . N), located under the part of the open sheet touched or to which the user finger has approached close enough. The increase of said capacity is determined by the increase of periods of pulses formed by pulse former 11, when a corresponding sensor is connected to its feedback network.

Activation point detection unit 8, the functions of which in the considered embodiments of the invention are fulfilled by controller 27 (FIG. 8) or controller 33 (FIG. 9), records in demultiplexer 18 and in multiplexer 19 (FIG. 5) number codes providing turn by turn connection via demultiplexer 18 of one of the pins of resistor 20.n to the output of pulse former 11, and via multiplexer 19 the cathode of corresponding diode 21.n to the input of pulse former 11. Sensor 9.n is connected to the point of connection of said resistor and diode, and the capacity between this sensor and the common bus determines the period of pulses formed by pulse former 11. The value of pulse periods is measured and stored in activation point detection unit 8.

The described procedure is fulfilled for all values n=1 . . . N. The loop of interrogation of sensors 9.1 . . . 9.N repeats periodically. In the interrogation loop, the measured pulse period for each sensor 9.n is compared to the pulse period for the same sensor stored in the previous interrogation loop. In the result, such number NT is determined that for sensor 9.NT the increase of pulse period compared to the previous interrogation loop is higher than for all other capacity sensors and it exceed the set threshold. The program fulfilling the above functions will be considered later.

In the device according to the first embodiment of the invention (FIG. 2), the code of number NP indicating the number of the last turned over sheet and the code of number NT indicating the number of sensor 9.NT for which the touch has been detected arrive at the first and second inputs of sound message reproducing unit 5 accordingly. In the result, a sound message is reproduced corresponding to the selected part on the selected page. Sound signal counts are consecutively read from message memory 29 (FIG. 8) and are forwarded to DAC 30, where they are converted into the analog form. The sound signal is amplified in amplifier 31 and reproduced via loudspeaker 32.

In the device according to the second embodiment of the invention (FIG. 4), codes of numbers NP and NT arrive at the first and second inputs of message number forming unit 15, accordingly, in which the code number for the message arriving at sound message reproducing unit 5 is formed. In the result, a sound message is reproduced corresponding to the selected part on the selected page.

In the described below flow-charts of the programs fulfilled by controllers 27 and 33 in the devices according to the first and second embodiments of the invention accordingly, the following designations are used: T is a array of N numbers, in which the measured values of pulse periods for sensors 9.1 . . . 9.N are stored, G is an array of N numbers, in which values of pulse period remembered for the use in the next loop are stored, nm is a number of the sensor for which the difference between the measured and the stored values of pulse periods is maximal, DTm is a value of said maximal difference between the measured and stored values of pulse periods, Thr is a threshold value of the difference between the measured and stored values of pulse periods, NT is a number of the sensor for which the touch is detected, U is a measured logical voltage level at the output of comparator 26 in sheets position sensor 12, NP is a number of the first not turned over sheet, NM is a number of a reproduced sound message, n is a counting variable.

The run of the program in the device according to the first embodiment of the invention (FIG. 10) begins when the power is switched on (block 41). Then the initialization takes place (block 42), in the process of which the values of pulse periods for all sensors 9.1 . . . 9.N are measured and the received values are recorded in the corresponding cells T[1] . . . T[N]. The procedure of measuring pulse periods is similar to the one used in subroutine 43 of determining the point of touch that will be described later.

Then the program goes into the loop comprising subroutine 43, program block 44, subroutine 45, and program blocks 46, 47. This loop continues till the power is switched off.

In the result of running subroutine 43 of determining the point of activation, number NT is found that shows the number of sensor 9.NT, for which the touch is detected. Subroutine 43 fulfils the functions of activation point detection unit 8. Then it is checked, if there is a touch (block 44). If NT=0, there is not touch and the program returns to the beginning of the loop to subroutine 43.

In the opposite case, subroutine 45 of determining the number of the open sheet is fulfilled, in the result of which NP is found showing the number of the first not turned over sheet. Subroutine 45 fulfils the functions of interrogation unit 13.

Then NM number of the message for reproduction is determined (block 46) according to the formula NM=(NP−1)*N+NT. Then the sound message with number NM is reproduced (block 47). The values of sound signal counts are consecutively read from message memory 29 (FIG. 8) beginning with the address determined by number NM and are forwarded to DAC 30. These operations repeat till all the sound signal counts are reproduced. If some method of sound compression was used during the recording of sound messages into message memory 29, then the corresponding decoding is fulfilled during the message reproduction. The program fulfilling these functions can be similar to those used in the known devices for recording and reproduction or for transmission of sound information. Thus, program blocks 46 and 47 fulfil the functions of sound message reproducing unit 5 in the device according to the first embodiment of the present invention.

Then the program returns to the beginning of the loop at subroutine 43.

The program run in the device according to the second embodiment of the invention (FIG. 11) also begins when the power is switched on (block 48). Initialization (block 49), subroutine 50 for determining the point of activation (block 51), subroutine 52 of determining the number of the open sheet, determining of the message number (block 53) are similar to the corresponding blocks of the program and to the subroutines in the program of the device according to the first embodiment of the invention. Running of the loop beginning with subroutine 50 and ending in program block 54 continues till the power is switched off.

The found number NM of a message for reproduction is sent to sound message reproducing unit 14 (block 54). Then the program returns to the beginning of the beginning of the loop at subroutine 50.

After receiving number NM, controller 35 in sound message reproducing unit 14 (FIG. 9) fulfils the program of reproducing sound messages. Sound signal counts are read beginning with the address determined by number NM from message memory 37 and are forwarded to DAC 38. If necessary, compressed sound information is decoded.

After getting into subroutine 43 of determining the point of touch (block 55 in FIG. 12) counting variable n receives the value of 1, and variable NT—the value of 0 (block 56). Then the loop of blocks 57 . . . 60 is repeated N times. In each run of the loop, the program measures periods of pulses formed by pulse former 11 upon connecting sensor 9.n, (n=1 . . . N) into its feedback.

At the beginning of each loop, the following is calculated: the value of number n1 sent to multiplexer 19 and showing the number of its input used (FIG. 5), the value of number n2 sent to demultiplexer 18 and showing the number of its output used is (block 57).

The value of n1 is found by formula n1=Trunc(n/NY), where NY is a number of outputs of demultiplexer 18, Trunc(x) is a function returning the whole part of argument x. Value n1 changes in the range from 0 to NX−1, where NX=N/NY is a number of multiplexer 19 inputs. Value n1=0 corresponds to the first output of demultiplexer 18. Value n2 is found by formula n2=n−n1×NY and changes in the range from 0 to NY−1. Value n2=0 corresponds to the first input of multiplexer 19.

In the result, sensor 9.n, where n=n1×NY+n2, is included into the feedback of pulse former 11. Pulse former 11 forms pulses, the period of which is determined by the capacity between said sensor and the common bus. Further, the pulse period is measured (block 58). This operation can be for example the operation of counting cycles in controller 27 (or 33) during the interval between two neighboring pulse fronts at the output of pulse former 11. The value received is stored in variable T[n].

Program blocks 59 and 60 provide the transition to the next run of the loop and its termination after the N-th run.

Then the subroutine calculates the difference between measured periods T[n] and stored after the previous run of the loop of the main program values of G[n] for all n=. . . N (block 61). In the result of the calculations, values of nm are determined, that is of the sensor number for which the difference between the measured and stored pulse period values is maximal; and DTm is determined, the value of said maximal difference between the measured and stored values of pulse period values.

Further, it is checked if there is a touch (block 62). For this purpose, DTm is compared to constant Thr, the threshold value for the difference between the measured and stored pulse period values. If DTm>Thr, then the touch for sensor 9.nm is detected. All stored for the use in the next loop pulse period values G[n] (n=1 . . . N) receive values of corresponding measured periods T[n] (block 63). Variable NT comprising sensor number, for which the touch has been detected, receives value nm (block 64). After this, the subroutine terminates in block 71.

In case if Dtm does not exceed the threshold, that is no touch is detected, counting variable n receives the value of 1 (block 65). After this, the loop of program blocks 66 . . . 70 is fulfilled, in which new values of G[n] (n=1 . . . N) are determined. In each run of the loop, the measured period T[n] is compared to an earlier stored value of G[n] (block 66). If T[n]<G[n], then variable G[n] receives the value of T[n] (block 67). In the opposite case, the new value of G[n] is found by formula G[n]=(3×G[n]+T[n])/4 (block 68). Thus, if period T[n] has increases but has not exceeded threshold Thr, value G[n] grows slowly that increases the reliability of the device. The formula for calculating G[n] can be different, but it has to ensure the above peculiarities for changes of the above values in time.

Then the value of variable n increases by 1 (block 69), and the condition for the loop termination is checked (block 70), by fulfilling which the subroutine terminates (block 71). Variable NT remains equal to 0 showing that no touch has been detected.

The described subroutine 43 of determining the point of touch provides the protection against a repeated activation, when the user keeps the finger on the same part of the sheet for a long time.

Besides, the subroutine smoothly follows the gradual increase or decrease in the capacity between sensors 9.1 . . . 9.N and the common bus taking place, when book sheets 4.1 . . . 4.M are turned over. As the values for the periods of each sensor 9.1 . . . 9.N are stored and analyzed separately, the influence of capacity range on said sensors is excluded.

Subroutine 50 of determining the point of touch in the device according to the second embodiment of the invention is similar to the described one.

After entering subroutine 45 for determining the number of the open sheet in block 72 (FIG. 13), counting variable n receives the value of 1, and variable NP showing the number of the first sheet that is not turned over receives the value of 0 (block 73). Then the loop consisting of program blocks 74 . . . 79 is fulfilled. In each run of the loop one pair of electrodes 22n. and 22.(n+1) is checked (FIG. 6).

In the beginning of each run of this loop, value n is sent to demultiplexer 24 and multiplexer 25 (block 74). Then the logical voltage level received from the output of comparator 26 is stored in variable U (block 75). Further, the value of variable U is compared to logical 0 (block 76). If the result of the comparison is negative (U corresponds to logical 1), that corresponds to the absence of the gap between electrodes 22n. and 22 (n+1), the value of variable n increases by 1 (block 78) and the condition for termination of the loop is checked (block 79). If this condition is not met, the program returns to the beginning of the loop in block 74. In the opposite case, that is if n>M+1, the subroutine terminates (block 80) NP retaining the value of 0. The similar situation takes place, if the book is closed.

If in program block 76 it is found out that U corresponds to the logical 0, that is electrodes 22n. and 22.n+1 are far enough from each other, variable NP receives the value of n (block 77). After this, the subroutine terminates in block 80.

Subroutine 52 of determining the number of the open sheet fulfilled in the device according to the second embodiment of the invention is similar to the described above.

### Conclusion, Ramifications and Scope

As it is clear from the description of the present invention, the invention provides sound-reproducing devices that have advantages over the devices known before. The devices according to the present invention are operative to automatically determine the number of the open sheet and to reproduce a sound message in accordance with said number and the point of the user activation of one of the open sheets. The change in the capacity between sensors and the common bus occurring when sheets are turned over is traced automatically that provides a precise determination of the sheet part touched even if a big number of sheets is placed above a capacity sensor. Thus, a higher reliability of the device is achieved.

The sound-reproducing devices according to the present invention can be used as educational books, toys, advertising magazines, guide books, etc. Automatic determining of the open sheet simplifies the use of the device and is advantageous for the user. Another advantage of the present invention devices is the possibility to use a big number of sheets in the device that increases the amount of text and graphic information while the corresponding sound information can be stored on a memory IC, on a magnet or laser disc. The sound-reproducing unit can be displaced both inside and outside of the present invention device. For example, a PC can be used or a regular sound-reproducing center allowing to increase volume and the sound quality and in same cases can be more convenient for the user.

The above and other advantages of the devices according to the present invention open wide possibilities for their commercial use.

Having described the preferred embodiments of the invention with the reference to the accompanying drawings, it is to be understood that the invention is not limited to these precise embodiments, and that various changes and modifications may be effective therein by one skilled in the art without departing from the scope or spirit of the invention as defined in the appended claims

We claim

1. A sound-reproducing device comprising a front and back covers fastened together with sheets located therebetween, a sound message reproducing unit, an impact sensors unit, the output of which is connected to the input of said sound message reproducing unit, sheet position detection unit, the output of which is connected to an additional input of said sound message reproducing unit, wherein said impact sensors unit is located so that to be capable of detecting user actions, said sheet position detection unit is located so that to be capable of determining sheets positions, and said sound message reproducing unit is operative to reproduce sound messages depending on code numbers on its inputs.

2. The sound-reproducing device of claim 1, wherein said sound message reproducing unit is located in the space limited by surfaces of at least one of said front cover and said back cover.

3. The sound-reproducing device of claim 1, wherein said impact sensors unit comprises an activation point detection unit, N sensors, a commutator, and a pulse former, each of said sensors being located in said front or back cover or on the surface of one of said covers and being connected to the corresponding input of said commutator, the output of which via said pulse former is connected to the input of said activation point detection unit, the first output of which is the output of said impact sensors unit and the second output is connected to the control input of said commutator.

4. The sound-reproducing device of claim 3, wherein said activation point detection unit, commutator and pulse former are located in the space limited by surfaces of at least one of said front cover and said back cover.

5. The sound-reproducing device of claim 3, wherein at least one of said sensors is a capacity sensor.

6. The sound-reproducing device of claim 5, wherein said at least one sensor comprises a fragment of a metallized coating of the circuit board.

7. The sound-reproducing device of claim 5, wherein said at least one sensor comprises a fragment of a conducting coating on an insulating film.

8. The sound-reproducing device of claim 3, wherein said activation point detection unit is operative:
to form on its second output cyclically repeating codes of numbers from 1 to N;
to measure N pulse periods on its input corresponding to numbers from 1 to N;
to store N pulse periods corresponding to numbers from 1 to N; and
to form on its first output a code of number K so that the difference between the K-th measured period and the K-th earlier stored period is maximal for all measured periods from the first till the N-th and exceeds a preset threshold.

9. The sound-reproducing device of claim 3, wherein said pulse former comprises a threshold element, the input of which is the input of said pulse former and via a resistor is connected to a common bus, the output of said threshold element is the output of said pulse former, and wherein said commutator comprises an additional input connected to the output of said pulse former, a demultiplexer and a multiplexer, control inputs of which are connected to the input of said commutator, the output of which is connected to the output of said multiplexer, and an additional input is connected to the input of said demultiplexer, each out of at least part of outputs of which is connected to each out of at least part of inputs of said multiplexer via a consecutively connected resistor and diode, the united outputs of which are connected to a corresponding output of said commutator.

10. The sound-reproducing device of claim 1, wherein said sheet position detection unit comprises a sheets position sensor and an interrogation unit, the input of which is connected to the output of said sheets position sensor and the output being the output of said sheet position detection unit.

11. The sound-reproducing device of claim 10, wherein said interrogation unit is operative to cyclically form codes of numbers from 1 to L on its additional output connected to the input of said sheets position sensor, and wherein said sheets position sensor comprises L electrodes, an alternating voltage generator, a demultiplexer, a multiplexer, and a comparator, the output of which is the output of said sheets position sensor, and the input is connected to the output of said multiplexer, the control input of which is connected to the input of said sheet position sensor and is connected to the control input of said demultiplexer, the input of which is connected to the output of said alternating voltage generator, said electrodes being displaced on at least part of said sheets so that capacity connection appears between the electrodes on adjoining sheets, when said sheets adjoin each other, and each of said electrodes being connected at least to the corresponding output of said demultiplexer and to the corresponding input of said multiplexer.

12. The sound-reproducing device of claim 11, wherein said sheets position sensor comprises at least one of an additional electrode displaced on the inner side of said front cover and an additional electrode displaced on the inner side of said back cover, and wherein each of said additional electrodes is connected at least to the corresponding output of said demultiplexer and to the corresponding input of said multiplexer.

13. A sound-reproducing device comprising a front and back covers bound together with sheets displaced therebetween, a sound message reproducing unit, an impact sensors unit displaced so that to detect the user activation, a sheet position detection unit, and a message number forming unit, the first and second inputs of which are connected to the outputs of said sheet position detection unit and said impact sensors unit accordingly, and the output is connected to the input of said sound message reproducing unit, which is operative to reproduce sound messages depending on a number code on its input.

14. The sound-reproducing device of claim 13, wherein said sound message reproducing unit is displaced in the space limited by the surfaces of at least of said front cover and said back cover.

15. The sound-reproducing device of claim 13, wherein said sound message reproducing unit is displaced outside of the space limited by the surfaces of said front and back covers.

16. The sound-reproducing device of claim 13, wherein the connection between the output of said message number forming unit and the input of said sound message reproducing unit is an optical connection.

17. The sound-reproducing device of claim 13, wherein the connection between the output of said message number forming unit and the input of said sound message reproducing unit is a radio connection.
